(19) United States
(12) Patent Application Publication
(10) Pub. No.: US 2024/0409287 A1
(43) Pub. Date: Dec. 12, 2024

(54) FLEXIBLE PAPER-POLYMER MULTILAYER PACKAGE, PREFERABLY FOR DRIED FOOD PRODUCTS

(71) Applicant: Barilla G. e R. Fratelli S.p.A., Parma (PR) (IT)

(72) Inventors: Luciano Bertozzi, Parma (PR) (IT); Francesca Righi, Parma (PR) (IT); Giacomo Canali, Collecchio (PR) (IT)

(73) Assignee: Barilla G. e R. Fratelli S.p.A., Parma (PR) (IT)

(21) Appl. No.: 18/736,059

(22) Filed: Jun. 6, 2024

(30) Foreign Application Priority Data
Jun. 6, 2023 (IT) 102023000011466

(51) Int. Cl. B65D 65/18; B31B 70/26; B31B 70/83; B31B 150/00; B31B 160/20; B31B 170/20; B65D 65/12; B65D 65/40

(52) U.S. Cl. CPC B65D 65/18; B31B 70/266; B31B 70/83; B65D 65/12; B65D 65/40; B31B 2150/003; B31B 2160/20; B31B 2170/20

(57) ABSTRACT

Paper-polymer multilayer package, preferably for dried food products, comprising: a front wall (2) and a rear wall (3) that are opposite, said walls defining at least one upper closing fin and being laterally connected to each other by two lateral walls (5). Said lateral walls define at least upper-folding portions (5u) folded over themselves and inserted in the respective closing fin, wherein upper lateral windows (7u) exposing a polymeric inner layer are provided at the upper-folding portions (5u).

### CROSS-REFERENCE TO RELATED APPLICATIONS

The present application claims priority to Italian Patent Application No. 102023000011466, filed Jun. 6, 2023, the entirety of which is incorporated herein by reference.

### FIELD OF APPLICATION

In its most general aspect, the present invention relates to a flexible bag-type package, preferably for food products, such as dried pasta, which is made from a reel of multilayer film having an outer layer made of paper material and a polymeric inner coating.

The invention may therefore have a useful application in the packaging field, in particular in the food-packaging field.

### PRIOR ART

The industrial packaging of dried pasta traditionally involves the use of rigid-cardboard boxes or of flexible bags made of polymeric material.

However, recently, a new type of flexible package has become widespread. Said new type of flexible package uses a sheet consisting of a thick paper internally coated with a polymeric material, for example polypropylene or polyethylene. The paper layer may locally have one or more openings that expose the underlying transparent polymeric layer, so as to allow the consumer to see the food product. Packages of this type allow in some cases a better recyclability and are in particular appreciated by the consumer because they evoke a traditional production size and the belonging of the food product to a premium category.

Although said packages made of paper/polymer coupled material substantially meet the needs of the field, they nonetheless have some thus far not solved defects that are discussed below.

First of all, it is to be noted that packages of the above-mentioned type are made from a reel of polycoupled film which is folded into a tubular shape, and then first longitudinally sealed, thereby defining a front face and a rear face connected by side faces. Then, the upper and lower end of the tubular body are also sealed along transverse closing fins, thereby preliminarily closing in a gusseted manner the corresponding portions of the side faces. The sealed fins are then possibly folded on the body of the bag.

Now, the transverse seals have, at the two sides of a central portion, two portions in which the polycoupled sheet is pleated according to a W-conformation. Obviously, said side portions have an increased thickness compared to the central thickness, in particular double the central thickness.

Therefore, during the sealing process, due to the different thickness, the pressure applied by the linear-type sealing bars cannot be the same at all the portions of the fin. In some cases, to solve said drawback, sealing bars having shaped profiles are used so as to locally apply the suitable pressure based on the fin thickness. To obtain a satisfactory sealing, it is further necessary to use specific process parameters, increasing bar pressure and temperature.

As a consequence of the above, the process performance deteriorates, resulting in a considerable increase of the production times and a consequent effect on the total packaging costs.

Moreover, a potential deterioration of the package quality is observed, wherein some packages have a weak sealing at the central portion having a lower thickness.

Therefore, said traditional method of bag forming and sealing entails an increase of waste during the production process, since bags having a sealing unsuitable for the use as a food package, and that are therefore unusable, might be obtained.

It is also to be noted that only a partial sealing is obtained in the pleated side portions of the two fins. Between the first and the second pleat, as well as between the third and the fourth pleat, the polymeric layers are facing each other, and it is therefore possible to make the sealing. However, between the second and the third pleat there is a contact between the two layers of paper-material, and this causes the sealing to be impossible without further expedients.

EP 3 275 799 A1 discloses a bag for horticultural or similar products comprising a front band and a back band made of paper, laterally joined by a first lateral band and a second lateral band made of plastic (which can be joined together), and transversally joined for forming a base (101) and a mouth (102) of the bag. This bag is formed from a tubular envelope obtained from a plastic sheet (5), which is coupled to a paper sheet (2, 3) only at the envelope's portions that are intended to form the front and the rear walls/bands of the bag. Therefore, this bag is not entirely made of a multilayer sheet comprising an outer layer made of paper material and an inner layer made of polymeric material.

US 2008/0014391 A1 discloses a process for manufacturing a laminate for forming a package having one or more windows for viewing the package contents. The process comprises the step of extrusion laminating, onto a first material perforated by a hole for and defining each of said windows, a heat-sealable second material.

The technical problem underlying the present invention is to provide a bag having features that can solve the drawbacks of the above-described prior art, in particular a bag that can be sealed with simpler and more efficient sealing processes, so as to reduce processing times and minimize waste.

### SUMMARY OF THE INVENTION

The present invention thus relates to a package, preferably for food products, entirely made of a multilayer sheet comprising at least one outer layer made of paper material and one inner layer made of polymeric material, said sheet defining a tubular envelope provided with a front wall and with a rear wall that are opposite and laterally connected to each other by two lateral walls, said tubular envelope being sealed at the top and at the bottom so as to define said package; wherein said package comprises at least one upper closing fin comprising upper-sealing portions of the front wall and of the rear wall, respectively, sealed with each other with upper-folding portions of the lateral walls folded over themselves and interposed therebetween.

The technical problem pointed out above has been solved by providing upper lateral windows in said package, in which the outer layer is absent, thereby exposing the inner layer, said upper lateral windows at least partially occupying said upper-folding portions.

Thanks to the above-mentioned expedient, a considerable thickness decrease at the folded lateral portions is obtained. As a matter of fact, although the outer pleats comprise a paper layer and an underlying polymer layer-thereby keeping unchanged the appearance of the package on the shelf-on the other hand, the two inner pleats are at least partially lacking the paper layer, so that the overall thickness of the pleated lateral portion is substantially equal to the thickness of the central portion. This makes transverse sealing considerably easier.

In other words, the paper-polymer multilayer package has a fin having a thickness that is substantially the same also at the folding sites; although it has four layers of the paper-polymer sheet at said sites, the lateral windows allow to locally reduce the thickness by eliminating paper where it is not visible nor necessary.

Preferably, the upper lateral windows open on both opposite faces of each upper-folding portion which is folded over itself, so that the exposed inner layer is sealed on itself at the site of folding over. In other words, there will be a condition of polymer-on-polymer interface also between the central pleats of the lateral portion, so that a strong sealing can also be obtained between said pleats during the transverse-sealing operation.

Preferably, only one single upper lateral window, which is continuous on each upper-folding portion, is provided. Said window can easily be created on the polymer layer with a single cut operation; said cut operation can equally create lower windows of a contiguous package.

Preferably, the upper lateral window extends to the upper end of the tubular envelope.

Also preferably, the upper lateral window does not occupy the front and rear wall, and it preferably does not extend to the edge of separation between the lateral wall and said walls. Thanks to this expedient, it is prevented that the user sees the portion lacking the paper covering when the product is on the shelf.

The above-mentioned upper closing fin, which in the shelf configuration is sealed—preferably by means of heat-sealing—may conveniently be unsealed, or else cut, by the user so as to define a mouth for accessing the product.

Preferably, the package also comprises a lower closing fin comprising: lower-sealing portions of the front wall and of the rear wall, respectively, sealed with each other with lower-folding portions of the lateral walls folded over themselves and interposed therebetween; and lower lateral windows wherein the outer layer is absent, thereby exposing the inner layer, said lower lateral windows at least partially occupying said lower-folding portions.

Essentially, the expedient used for sealing the upper fin can thus also be used to seal the lower portion of the sealing. In the preferred embodiment, the two sealing operations occur at the same time by means of a single sealing bar.

Preferably, the multilayer sheet is a coupled sheet comprising only two layers: a paper outer layer and a polymeric inner layer, preferably a film made of polypropylene and/or polyethylene.

In a preferred embodiment, the inner polymeric layer is transparent, whereas the paper layer may be printed with commercial information about the product. In any case, the idea of the invention may also be used with an opaque or translucent inner polymeric layer, since only the material's capability of being sealed is essential for the purposes of the solution.

The above-mentioned technical problem is also solved by a method for the production of a package, preferably intended for food products, comprising the steps of:
coupling at least one outer layer made of paper material and one inner layer made of polymeric material to form a multilayer sheet;
shaping and longitudinally sealing said multilayer sheet on itself to form a tubular envelope provided with a front wall and with a rear wall that are opposite and laterally connected to each other by two lateral walls;
coupling upper-sealing portions of the front wall and of the rear wall, respectively, by folding between them upper-folding portions of the lateral walls;
sealing at the top, along an upper closing fin, said upper-sealing portions with the upper-folding portions interposed, thereby making an upper sealing;
sealing at the bottom said tubular envelope, thereby making a lower sealing;
said method further comprising a step, which is preliminary to making the upper sealing, of obtaining upper lateral windows in which the outer layer is absent, thereby exposing the inner layer, said upper lateral windows at least partially occupying said upper-folding portions.

The step of obtaining the upper lateral windows is preferably performed upstream of the step of coupling the outer layer to the inner layer by cutting out specific portions of a continuous film of the outer layer.

Preferably, said sealing step occurs by heat-sealing.

Preferably, the expedients and the sealing operations used to make the upper sealing are replicated in a substantially equal manner to make the lower sealing.

Preferably, the upper sealing and the lower sealing are made at the same time, by applying the sealing bar onto a portion of the envelope which has not been divided into single packages yet. The cut separating the distinct packages is preferably made simultaneously with said double sealing.

In particular, said step of obtaining the upper lateral windows can be performed by laser cutting or by die-cutting.

Advantageously, in the present invention, the transverse sealing does not require specific adjustments such as the use of shaped sealing bars, neither does it require an increase of the used sealing times and/or temperatures.

Advantageously, said method for obtaining the package according to the invention entails waste reduction, thanks to the application onto the entire fin of a pressure and a temperature that are the same along a substantially uniform thickness.

Even more advantageously, said method allows to reduce processing times, therefore increasing the production rate with a cost reduction.

The advantages and features of the flexible package according to the present invention will become clearer from the description of an exemplary embodiment thereof provided hereinbelow with reference to the attached drawings provided by way of a non-limiting example.

### BRIEF DESCRIPTION OF THE DRAWINGS

FIG. 1 shows a first step of making a bag-type package according to the present invention in a perspective view.

FIG. 2 shows a second step of making the bag-type package of FIG. 1 in a perspective view.

FIG. 3 shows a third step of making the bag-type package of the previous figures in a perspective view.

FIG. 4 shows a fourth step of making the bag-type package of the previous figures in a perspective view.

FIG. 5 shows a bag-type package made according to the present invention in a perspective view.

FIG. 6 shows a simplified sectional view of the sheet used to make the package according to the present invention at an upper lateral window.

FIGS. 7a-f show, in a simplified section, the steps of folding and sealing of a package according to the present invention at the formation of the upper sealing.

FIG. 8 shows a blank of the paper-plastic coupled sheet used to make the package according to the present invention, wherein dashed lines indicate folding lines, dot-dash lines indicate cut lines and internal solid lines indicate the windows in which the paper layer is removed.

### DETAILED DESCRIPTION OF A PREFERRED EMBODIMENT

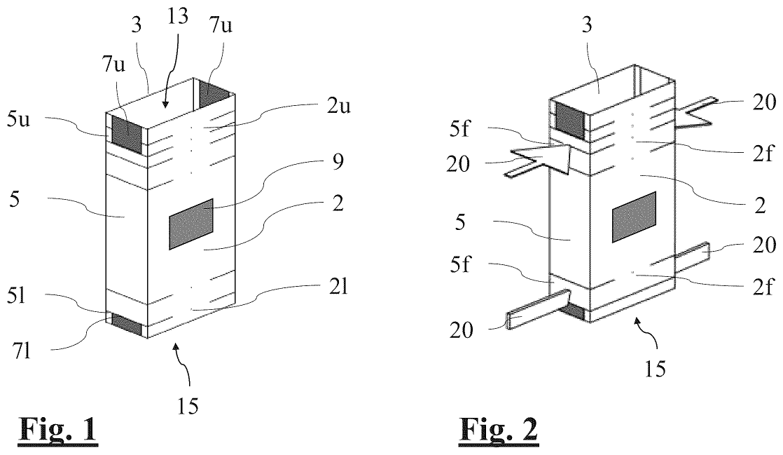

With reference to the attached FIGS. 4 and 5, 1 generically refers to a flexible bag-type package for dried food products, in particular for products such as short pasta.

The position references used in the present description, comprising indications such as “front” or “rear”, “in front of” or “behind”, “lower” or “upper”, “below” or “above”, “laterally” or similar terms, in all cases refer to the illustrative configuration shown in the above-mentioned figures and must not in any case be attributed any limiting value. In particular, it is possible that the package is designed to lie on its sealing-less faces, below identified as front and rear face: in this case, the described package extends horizontally rather than vertically as it is visible in the attached figures.

With particular reference to the terms “front” or “rear”, it is pointed out that these are mainly used for the sake of easier description and, although they suggest a preferred orientation of the package on the shelf of the distribution outlet, they must not be regarded as having a limiting meaning. In particular, it is possible for the face described here as “rear” to be printed or otherwise decorated with brand markings and/or pictures of the product such that it may be placed on display so as to face the consumers.

The flexible package 1, below simply referred to as “package”, has a substantially parallelepiped shape with a front wall 2 and a rear wall 3, opposite and identical to each other, and lateral walls 5 which laterally connect said front and rear walls. Of course, product variants may have other shapes than the parallelepiped shape, for example a prismatic shape. The front wall 2 and rear wall 3 are joined together at the top in the form of an upper closing fin 4 where the two top edge zones of these walls are heat-sealed or in any case sealed using a suitable method. At the bottom, the package 1 has a support base 14 defined by a suitably folded bottom fin or in any other manner known to the person skilled in the art.

The above-mentioned upper closing fin 4, in a per se known manner, may be unsealed or in any case torn along the seal, so as to define a mouth 13 for accessing the products—in the preferred example dried pasta—contained inside the package 1.

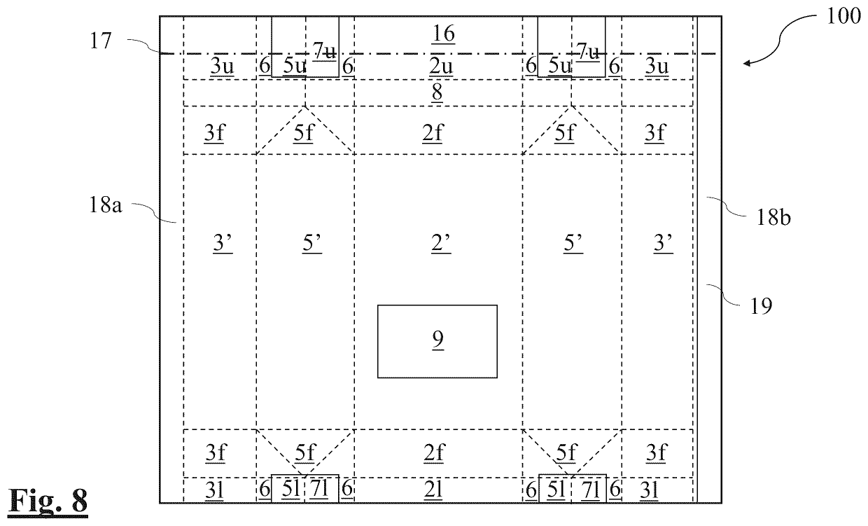

The whole package 1 is preferably made from a single blank 100, shown in FIG. 8, suitably folded over itself and sealed along at least three sealing lines as described below.

The blank 100 is made from a sheet 10 comprising an outer layer 11 made of flexible paper material, suitably printed according to the commercial needs of the manufacturer, and an inner film 12 made of polymeric material, preferably polypropylene. The two materials are integrally coupled with each other, for example by lamination, so as to define a single and cohesive sheet. Preferably, the sheet is unwound from a reel.

In some areas, the blank has windows in which the paper outer layer 11 has been removed, thereby exposing the polymeric inner layer 12. Said windows are preferably obtained by laser cutting or by die-cutting directly on a paper film defining the outer layer 11, upstream of the coupling by lamination.

The blank 100 has one front part 2′ corresponding to the front wall 2 of the package 1, two lateral parts 5′ corresponding to the lateral walls 5 and two rear parts 3′ which, joined together by a longitudinal sealing, define the rear wall 3.

In particular, the rear part 3′ has an upper longitudinal sealing strip 18a and a lower longitudinal sealing strip 18b, which are overlapped and on which the longitudinal sealing is made. Preferably, the lower longitudinal sealing strip 18b is entirely or almost entirely occupied by a longitudinal window 19. The polymeric material, that is exposed at the top, of the longitudinal window 19 becomes sealed with the inner layer 12 of the upper longitudinal sealing strip 18a.

The parts 2′, 3′, 5′ of the blank 100 have transition portions 2f, 3f, 5f at the bottom and at the top. In the finished package, the front transition portions 2f and the rear transition portions 3f fold over the parallelepiped body containing the food product, thereby defining its lower and upper face. Instead, the lateral transition portions 5f are inserted in a gusseted manner between the corresponding front transition portion 2f and rear transition portion 3f.

Besides the transition portions 5f, the lateral parts 5 have lower folding portions 51 and upper folding portions 5u, which are enclosed as in a book between lower sealing portions 21, 31 and upper sealing portions 2u, 3u of the front and rear part. The upper-sealing portions 2u, 3u are separated from the transition portions 2f, 3f by a free area 8, whereas above them there is an upper strip 16 which is later on cut along a cut line 17 after re-closing the package 1.

The folding portions 51, 5u have corresponding lower lateral windows 71 and upper lateral windows 7u, free from the paper outer layer 11, surrounded by double-layer short connection segments 6 that arrive at the fold with the sealing portions 21, 31, 2u, 3u. When the lateral windows 71, 7u are folded over themselves in the final conformation of the product, they internally define a mutual contact between the two polymeric inner layers 12, thereby allowing a strong sealing between the two wings defined by the W-folding of the folding portions 51, 5u.

Moreover, on the front wall 2, a central window 9 is obtained in the paper outer layer, said central window being intended for showing the content of the bag to the consumer. Said window may be not present if it is considered to be not necessary.

To obtain the package according to the invention, the blank 100 is first folded to form a tubular envelope 15, with a sealing made along the overlapped longitudinal sealing strips 18a, 18b, as shown in FIG. 1.

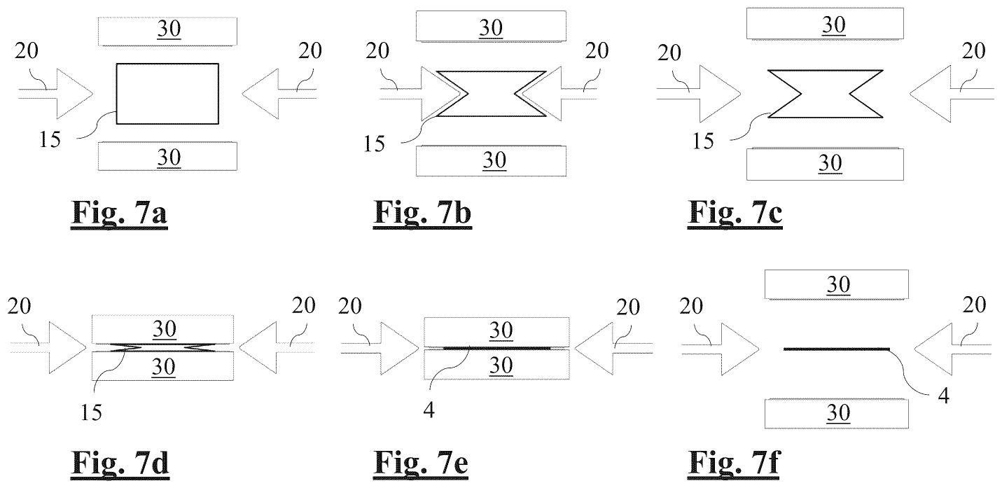

Then, by means of suitable folding lances 20 or similar devices, the upper folding portions 5u and the lower folding portions 51 are folded inwards, as shown in FIG. 2 or, more in detail, in the schematic FIGS. 7a-7c. Therefore, at the folding portions 5u, 51, the lateral walls 5 are folded in a gusseted manner, so that the windows 7u and 71 are brought inside the corresponding fin 4, 14.

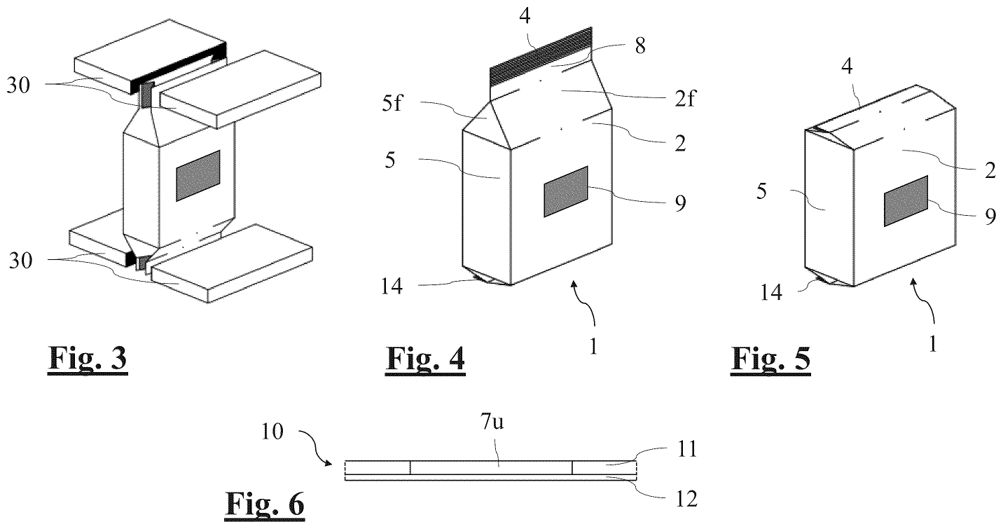

The upper fin 4 and the lower fin 14 are then sealed by means of heat-sealing bars 30, set on suitable temperature and pressure parameters, as shown in FIG. 3 or, more in detail, in FIGS. 7d-7f. In general, a same heat-sealing bar 30 operates on two consecutive packages made from a same reel of continuous sheet. At the same time, the cut, namely the separation of the successive packages, takes place.

Subsequently, the transition portions 2f, 3f, 5f are pushed against the lower face of the package 1, folding the lower fin 14 on said face, as shown in FIG. 4.

The upper fin 4 is then cut at the top along the cut line 17 and it is also folded, with collapse of the neighboring transition portions, against the upper face of the package 1, as shown in FIG. 5. In this case, a double folding of the upper fin 4 on top of the package 1 may be provided.

The presence of the free area 8 under the upper fin 4 allows the user to subsequently reopen more easily the mouth 13 for accessing the products, possibly closing again the package by folding the upper part.

The flexible package described above may be subject to other variants and modifications, all of which are within the reach of the persons skilled in the art and, as such, fall within the scope of protection of the present invention defined by the following claims.

1. A package, entirely made of a multilayer sheet comprising at least one outer layer made of paper material and one inner layer made of polymeric material, said sheet defining a tubular envelope provided with a front wall and with a rear wall that are opposite and laterally connected to each other by two lateral walls, said tubular envelope being sealed at the top and at the bottom so as to define said package;
wherein said package comprises at least one upper closing fin comprising upper-sealing portions of the front wall and of the rear wall, respectively, sealed with each other with upper-folding portions of the lateral walls folded over themselves and interposed therebetween;
wherein said package comprises upper lateral windows in which the outer layer is absent, thereby exposing the inner layer, said upper lateral windows at least partially occupying said upper-folding portions.

2. The package according to claim 1, wherein said upper lateral windows open on both opposite faces of each upper-folding portion which is folded over itself, so that the exposed inner layer is sealed on itself at the site of folding over.

3. The package according to claim 2, wherein only one single upper lateral window, which is continuous on each upper-folding portion, is provided.

4. The package according to claim 3, wherein the upper lateral window extends to the upper end of the tubular envelope.

5. The package according to claim 1, comprising a lower closing fin comprising:
lower-sealing portions of the front wall and of the rear wall, respectively, sealed with each other with lower-folding portions of the lateral walls folded over themselves and interposed therebetween; and
lower lateral windows wherein the outer layer is absent, thereby exposing the inner layer, said lower lateral windows at least partially occupying said lower-folding portions.

6. The package according to claim 1, wherein the multilayer sheet comprises only two layers.

7. The package according to claim 1, wherein the inner layer is a film made of polypropylene and/or polyethylene.

8. A method for producing a package, comprising the steps of:
coupling at least one outer layer made of paper material and one inner layer made of polymeric material to form a multilayer sheet;
shaping and longitudinally sealing said multilayer sheet on itself to form a tubular envelope provided with a front wall and with a rear wall that are opposite and laterally connected to each other by two lateral walls;
coupling upper-sealing portions of the front wall and of the rear wall, respectively, by folding between them upper-folding portions of the lateral walls;
sealing at the top, along an upper closing fin, said upper-sealing portions with the upper-folding portions interposed, thereby making an upper sealing;
sealing at the bottom said tubular envelope, thereby making a lower sealing;
wherein said method further comprises a step, which is preliminary to making the upper sealing, of obtaining upper lateral windows in which the outer layer is absent, thereby exposing the inner layer, said upper lateral windows at least partially occupying said upper-folding portions.

9. The method according to claim 8, wherein the step of obtaining the upper lateral windows is performed upstream of the step of coupling the outer layer to the inner layer by cutting out specific portions of a continuous film of the outer layer.

10. The method according to claim 9, wherein said step of obtaining the upper lateral windows is performed by laser cutting and/or by die-cutting.
